(19) United States
(12) Patent Application Publication
(10) Pub. No.: US 2026/0131465 A1
(43) Pub. Date: May 14, 2026

(54) SYSTEM FOR GUIDING MOBILE ROBOT TO STATION

(71) Applicant: SEOROBOTICS CO., LTD., Anyang-si, Gyeonggi-do (KR)

(72) Inventors: Hyo Seok BANG, Anyang-si, Gyeonggi-do (KR); Ho Gun KIM, Hwaseong-si, Gyeonggi-do (KR); Hyung Kak LEE, Gwangju (KR); Jeong Yeon JO, Suwon-si, Gyeonggi-do (KR); Nam Jong KIM, Siheung-si, Gyeonggi-do (KR); Ji In CHUNG, Bucheon-si, Gyeonggi-do (KR)

(21) Appl. No.: 19/479,101

(22) PCT Filed: Apr. 16, 2025
(86) PCT No.: PCT/KR2025/095212

§ 371 Date: Oct. 27, 2025

(30) Foreign Application Priority Data
Jun. 24, 2024 (KR) 10-2024-0081884

(51) Int. Cl. B25J 9/16; B25J 5/00; B25J 19/02

(52) U.S. Cl. CPC B25J 9/1664; B25J 5/007; B25J 9/1697; B25J 19/023

(57) ABSTRACT

A system for guiding a mobile robot to a station includes a station to which a mobile robot is connected to charge the mobile robot; and a display installed at the station, on which a video is displayed, wherein a marker image including orientation information of an X-axis, a Y-axis, and a Z-axis is displayed on the display, and the mobile robot calculates an orientation value and distance value relative to the station from a captured video image of the marker image to set an entry path, and enters the station based on the set entry path.

### TECHNICAL FIELD

The present invention relates to a system for guiding a mobile robot to enter a station by referring to a marker image when the mobile robot is to dock at the station.

### BACKGROUND ART

Generally, a mobile robot may be manufactured to perform a designated function, may use battery power, and may be equipped with a device for performing a designated function.

The battery power is consumed as the mobile robot operates, and the mobile robot must be charged to continue operating.

In addition, the designated function of the mobile robot may require replenishing water, for example, in the case of fire suppression, or may require discharging collected dust and washing a mop, in the case of cleaning.

A station enables the mobile robot to automatically take measures necessary to continue performing its designated function.

The mobile robot may travel along a preset path or move to a destination while avoiding obstacles by analyzing information collected through a camera and various sensors, and must return to the station when the remaining battery level reaches a set value or when measures are needed to perform its designated function.

An existing system for guiding a mobile robot to a station will be described with reference to FIGS. 1 to 3. FIGS. 1 and 2 are diagrams for explaining an existing system for guiding a mobile robot to a station.

A station 10 is installed, and one marker 20 is formed on a side wall of the station 10.

The marker 20 includes coordinate information. More specifically, when the marker 20 is captured by a camera, it is recognized by an image processor of the mobile robot. In image analysis, the marker 20 may be analyzed through marker recognition 30, and the marker recognition 30 may analyze recognition coordinates 40.

The recognition coordinates 40 include orientation information of an X-axis 41, a Y-axis 42, and a Z-axis 43, and based on this orientation information, the orientation posture of the mobile robot may be estimated.

The X-axis 41 is an axis indicating a direction perpendicular to and passing through a reference point of the marker 20, the Y-axis 42 is an axis indicating a horizontal direction from the reference point of the marker 20, and the Z-axis 43 is an axis indicating a vertical direction from the reference point of the marker 20.

In addition, the distance from the mobile robot to the marker 20 may be estimated using a distance sensor mounted on the mobile robot.

The mobile robot is equipped with a camera for capturing images, a distance sensor for detecting distances, and an image processing unit for analyzing camera images. The distance sensor may be a sensor that measures the distance to a measurement target.

When the mobile robot returns to the station, the approximate position coordinates of the station are pre-inputted, and it travels toward those position coordinates.

The mobile robot should enter the station in a preset approach posture, thereby allowing necessary measures to be taken for the mobile robot, such as charging the power supply, replacing consumables, or replenishing supplies as described above.

As the mobile robot travels autonomously, it may enter the station from an arbitrary position.

Regardless of its position, the mobile robot must align itself in the correct posture before the distance between the mobile robot and the station narrows to a set reference distance D. This allows the mobile robot to dock relative to the station.

An example of the mobile robot entering the station depending on the region in which it is located will be described with reference to FIG. 2.

A first region A1 is an area where the mobile robot's camera can capture the marker 20 from a nearly frontal position. The mobile robot can clearly recognize and analyze the marker 20 to analyze accurate position information, thereby allowing the mobile robot to align in the correct posture within the reference distance D and enter the station.

When the mobile robot is in the first region A1, it can clearly recognize the marker 20, which allows the mobile robot to align in the correct posture before reaching the reference distance D and enter the station.

A second region A2 is an area where the mobile robot's camera may capture the marker 20 at an angle.

When the mobile robot is in the second region A2, there is a possibility that it may not clearly analyze the information contained in the marker 20 even if it recognizes the marker 20, which poses a problem in that the mobile robot may fail to dock relative to the station.

A third region A3 is an area where the mobile robot's camera cannot capture the marker 20.

When the mobile robot is in the third region A3, it may not recognize the marker 20, and as a result, the mobile robot must repeatedly retreat and wander until it moves to an area where the marker 20 can be recognized, which poses a problem in that much time and remaining battery life are consumed in this process.

On the other hand, the mobile robot recognizes marker 20 through the camera, and generally, a wide-angle lens is applied as the camera lens. The reason for applying a wide-angle lens is to collect more information from a wide angle of view. That is, since a large amount of information is contained in a limited image size, the marker 20 is captured in a distorted and smaller form than its actual size.

In particular, the size of marker 20 in the captured video image has a characteristic of being captured smaller in proportion to the distance between the mobile robot and the marker.

If the marker 20 is captured too small in the video image, it is difficult to recognize the marker 20 and marker recognition may fail, posing a problem where the mobile robot cannot enter the station and wanders near it so as to recognize the marker.

On the other hand, the marker 20 contains information necessary for a specific mobile robot to enter the station, but there is a security vulnerability in the operation of the mobile robot, as a person with malicious intent may imitate the corresponding marker 20 and install a counterfeit marker in an unintended place, causing significant disruption to the mobile robot's operation.

On another hand, the station is a fixed structure, the mobile robot is self-driving, and the mobile robot's travel path may be walkways used by people. For this reason, there may be a risk of collision with a pedestrian when the mobile robot returns to the station, and although it must wait for a person to pass to avoid a collision, the person does not know the mobile robot's path of travel and therefore does not know where to move to avoid it, posing a problem that time may be wasted while hesitating.

### RELATED ART DOCUMENTS

### Patent Documents

(Patent Document 1) KR 10-2559299 B1
(Patent Document 2) KR 10-2023-0097356 A
(Patent Document 3) KR 10-2436960 B1
(Patent Document 4) KR 10-2023-0117825 A
(Patent Document 5) KR 10-1828441 B1

### DISCLOSURE

### Technical Problem

Therefore, the present invention has been made in view of the above problems, and it is one object of the present invention to provide a system for guiding a mobile robot to a station by enabling the mobile robot to recognize a marker more quickly and accurately when returning to the station.

It is another object of the present invention to provide a system for guiding a mobile robot to a station, whose security vulnerabilities have been improved to prevent interference with the mobile robot's operation by individuals with malicious intent.

It is still another object of the present invention to provide a system for guiding a mobile robot to a station which can prevent collisions between the mobile robot and pedestrians by illuminating the floor around the station to visually indicate the travel path of the mobile robot, thereby drawing the pedestrian's attention.

It is yet another object of the present invention to provide a system for guiding a mobile robot to a station which ensures the mobile robot aligns in a correct posture when approaching the station even from an arbitrary position.

### Technical Solution

In accordance with an aspect of the present invention, the above and other objects can be accomplished by the provision of a system for guiding a mobile robot to a station, the system including: a station 10 to which a mobile robot 100 is connected to charge the mobile robot 100; and a display 50 installed at the station 10, on which a video is displayed, wherein a marker image 60 including orientation information of an X-axis 41, a Y-axis 42, and a Z-axis 43 is displayed on the display 50, and the mobile robot 100 calculates an orientation value and distance value relative to the station 10 from a captured video image of the marker image 60 to set an entry path P, and enters the station 10 based on the set entry path P.

In addition, in the system for guiding a mobile robot to a station according to an embodiment of the present invention, the marker image 60 may be updated at set time intervals or each time the mobile robot 100 returns, and the data of the updated marker image 60 may be synchronized by the station 10 and the mobile robot 100.

In addition, in the system for guiding a mobile robot to a station according to an embodiment of the present invention, the marker image 60 may be displayed while changing its size within a range from a maximum size that can be displayed on the display 50 to a minimum size that can be recognized by the mobile robot 100.

In addition, in the system for guiding a mobile robot to a station according to an embodiment of the present invention, the marker image 60 may be displayed at a maximum size when a distance value farther than a set distance value is calculated based on the distance value between the station 10 and the mobile robot 100, and a size of the marker image 60 may be gradually displayed smaller in proportion to the distance value when a distance value closer than the set distance value is calculated.

In addition, in the system for guiding a mobile robot to a station according to an embodiment of the present invention, the marker image 60 may be rendered in a distorted form and displayed when the orientation value of the mobile robot 100 with respect to the station 10 is greater than ‘45 degrees’, so that the distortion of the marker image in the captured video image is reduced when the mobile robot 100 captures the marker image 60.

In addition, the system for guiding a mobile robot to a station according to an embodiment of the present invention may further include: a warning light 70 installed on one side of the station 10, wherein the warning light 70 illuminates a floor to display the entry path of the mobile robot 100 when the distance value between the mobile robot 100 and the station 10 falls within a set distance value as the mobile robot 100 returns to the station 10.

In addition, in the system for guiding a mobile robot to a station according to an embodiment of the present invention, the display 50 may have a plurality of screens, and a marker image 60 is displayed on each screen.

In addition, in the system for guiding a mobile robot to a station according to an embodiment of the present invention, the display 50 may have a convex curved shape, and a plurality of marker images 60 may be arranged apart in the horizontal direction and displayed.

Specific details of other embodiments are included in the detailed description and the accompanying drawings.

### Advantageous Effects

A system for guiding a mobile robot to a station according to an embodiment of the present invention can display a marker on a display, expose a large marker image when the distance between the mobile robot and the station is far, and reduce the size of the marker image as the distance becomes closer. This allows the mobile robot to capture a large-sized marker image even when it is far from the station, which can enable the rapid and accurate calculation of the mobile robot's relative orientation value and distance to the station to be reflected in the entry path generation, thereby optimizing the mobile robot's entry path.

In addition, the system for guiding a mobile robot to a station according to an embodiment of the present invention can newly update the marker when reproducing it on the display and synchronize the marker information between the station and the mobile robot. By doing so, even if an outsider misappropriates the exposed marker image for malicious purposes, the stolen marker can be nullified, thus improving the security vulnerability in mobile robot operation.

Furthermore, the system for guiding a mobile robot to a station according to an embodiment of the present invention can illuminate the floor around the station to visually indicate the mobile robot's path of travel. This can draw a pedestrian's attention, allowing them to avoid a collision with the mobile robot, thereby promoting pedestrian safety and contributing to the swift return of the mobile robot to the station.

In addition, the system for guiding a mobile robot to a station according to an embodiment of the present invention has an effect in that, even if the mobile robot is in an arbitrary position when it approaches a station, it can recognize at least one of a plurality of markers, estimate the distance to the marker, and clearly ascertain the orientation posture of the mobile robot. Accordingly, the travel path of the mobile robot can be optimized, and the time it takes for the mobile robot to dock relative to the station can be reduced.

In particular, the system for guiding a mobile robot to a station according to an embodiment of the present invention has an effect in that it can recognize and analyze marker images in an image captured by the mobile robot's camera, can quickly generate a travel path P based on the analysis results, and allows the mobile robot to be aligned in a correct posture to approach the station.

### DESCRIPTION OF DRAWINGS

FIG. 1 is a diagram for explaining an existing station for a mobile robot.

FIG. 2 is a diagram for explaining a marker configuration in an existing station for a mobile robot.

FIG. 3 is a diagram for explaining an example of a mobile robot returning to a station, as an existing example.

FIG. 4 is a diagram for explaining a system for guiding a mobile robot to a station according to an embodiment of the present invention.

FIG. 5 illustrates a station as seen from the perspective of the mobile robot, as an embodiment of the present invention.

FIG. 6 illustrates a marker image that is output to the display in FIG. 5.

FIGS. 7 and 8 illustrate a modified marker image transformed to reduce distortion from the perspective of the mobile robot, as an embodiment of the present invention.

FIGS. 9 and 10 are examples of outputting content to a display, as an embodiment of the present invention.

FIG. 11 is an example of outputting a marker image together with content on a display, as an embodiment of the present invention.

FIG. 12 is a diagram for explaining a system for guiding a mobile robot to a station according to another embodiment of the present invention.

FIG. 13 is a diagram for explaining the operation of a station for a mobile robot according to another embodiment of the present invention.

FIG. 14 is another example of a display in the system for guiding a mobile robot to a station according to an embodiment of the present invention.

FIG. 15 is a flowchart for explaining the operation of the system for guiding a mobile robot to a station according to an embodiment of the present invention.

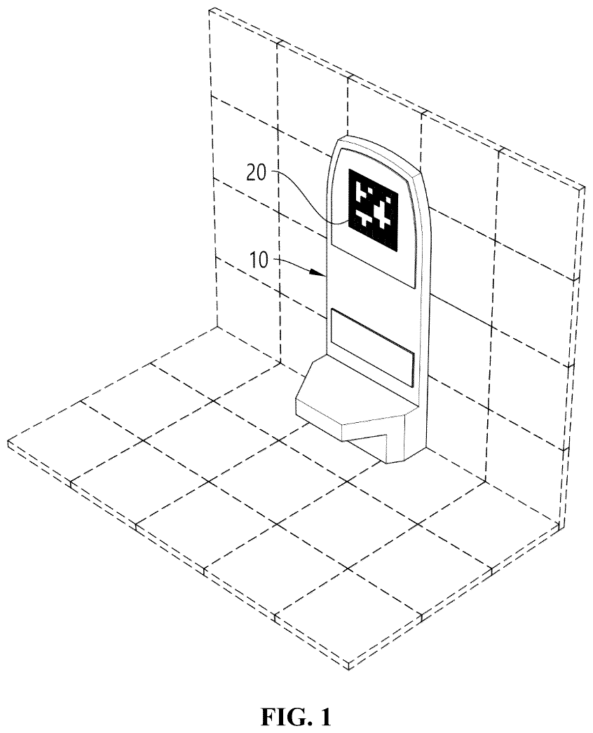

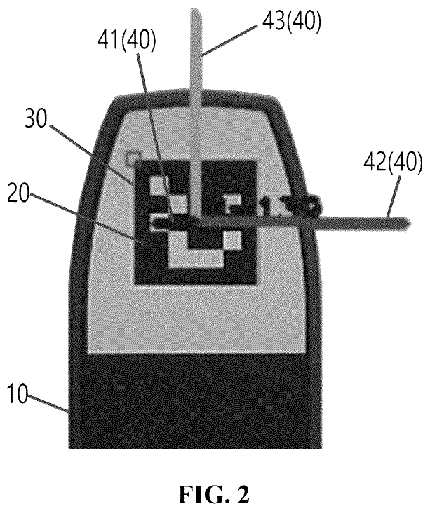

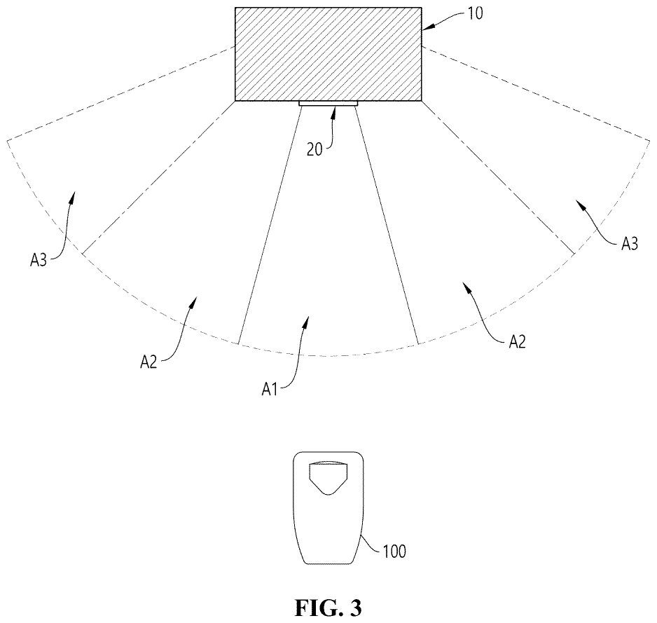

### BEST MODE

The advantages and features of the present invention and the method of achieving them will become apparent with reference to the embodiments described in detail below together with the accompanying drawings.

Hereinafter, an embodiment of the present invention will be described in detail with reference to the accompanying drawings. The embodiment described below is provided as examples to help understand the present invention, and it should be understood that the present invention can be implemented in various ways different from the embodiment described herein. However, in the following description of the present invention, a detailed description of known functions and configurations incorporated herein will be omitted when it may make the subject matter of the present invention unclear. In addition, the accompanying drawings are not drawn to their actual scales and some components may be drawn with exaggerated sizes to help understand the invention.

[Description of Symbols]

| | |
|---|---|
| 10: station | 20: marker |
| 30: marker recognition | 40: recognition coordinates |
| 41: x-axis | 42: y-axis |
| 43: z-axis | |
| 50: display | 60, 60a: marker image |
| 70: warning light | 100: mobile robot |
| P: travel path | D: secured minimum distance |

### MODE FOR CARRYING OUT THE INVENTION

Meanwhile, terms such as first, second, etc. may be used to describe various components, but the components should not be limited by the terms. The terms are used solely for the purpose of distinguishing one component from another. For example, without going beyond the scope of the present invention, the first component may be named the second component, and similarly, the second component may also be named the first component.

On the other hand, the terms described below are terms established in consideration of their functions in the present invention and thus may vary depending on the intention of a producer or custom. Accordingly, the definitions of the terms should be understood on the basis of the entire description of the present specification.

Throughout the specification, like reference numerals denote like elements.

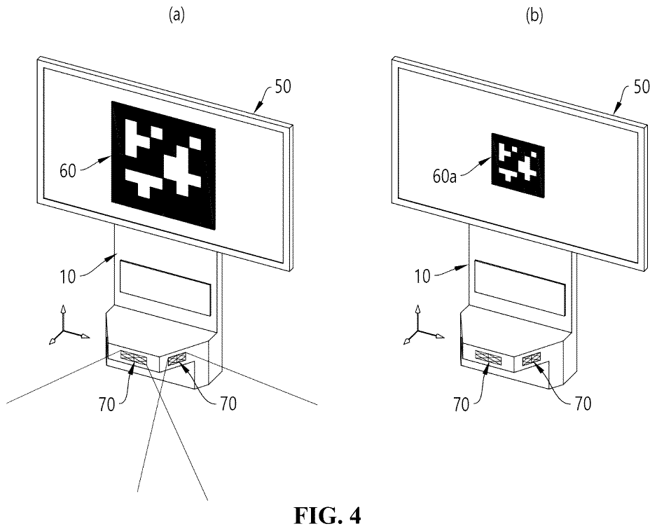

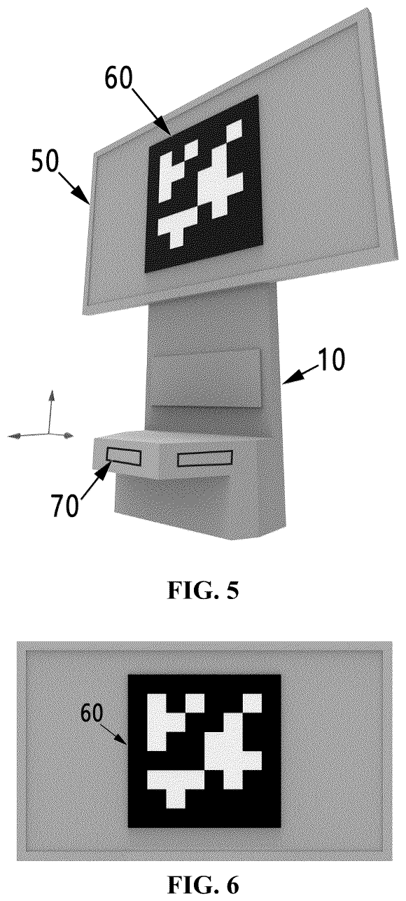

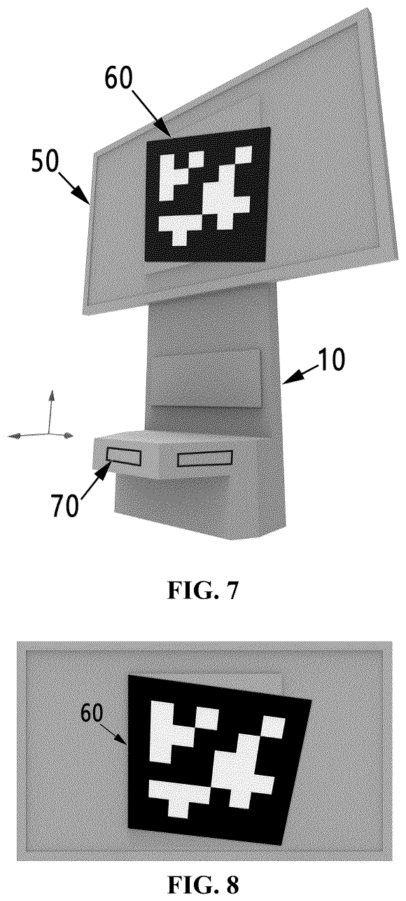

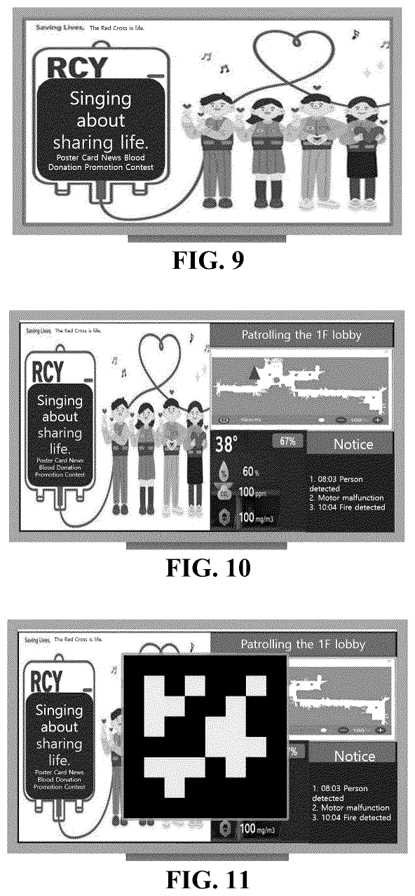

First, a system for guiding a mobile robot to a station according to an embodiment of the present invention will be described with reference to FIGS. 4 to 11. FIG. 4 is a diagram for explaining a system for guiding a mobile robot to a station according to an embodiment of the present invention. FIG. 5 illustrates a station as seen from the perspective of a mobile robot, as an embodiment of the present invention. FIG. 6 illustrates a marker image output to the display in FIG. 5. FIGS. 7 and 8 illustrates a modified marker image transformed to reduce distortion from the perspective of the mobile robot, as an embodiment of the present invention. FIGS. 9 and 10 are examples of outputting content to a display, as an embodiment of the present invention. FIG. 11 is an example of outputting a marker image together with content on a display, as an embodiment of the present invention.

The system for guiding a mobile robot to a station according to an embodiment of the present invention may include a mobile robot 100, a station 10 and a display 50.

The station 10 allows the mobile robot 100 to connect and be charged.

In addition, the station 10 may provide various services for the mobile robot 100 to perform its inherent functions.

For example, if the mobile robot 100 is for cleaning purposes, the various services may include washing a mop of the mobile robot 100, supplying clean water, discharging contaminated water, and discharging collected dust at the station 10.

If the mobile robot 100 is for fire suppression purposes, the station 10 may check the status of the fire suppression equipment mounted on the mobile robot 100.

Furthermore, the mobile robot 100 may be equipped with a plurality of cameras and capture video using the cameras to obtain image data, and the image data may be processed by an image analysis program to acquire desired data.

In addition, the mobile robot 100 may be equipped with a sensor to detect the shape and distance of surrounding objects.

Meanwhile, the station 10 and the mobile robot 100 may communicate data. The data included in the data communication may include an orientation value and distance value of recognition coordinates 40 contained in a marker image 60. Data communication uses known communication technologies, and a detailed description thereof is omitted.

The display 50 is installed at the station 10 and may display video.

The video may be content displayed according to the user's will or a marker image 60 displayed to guide the return of the mobile robot 100.

The marker image 60 includes orientation information of an X-axis 41, a Y-axis 42, and a Z-axis 43.

The mobile robot 100 calculates an orientation value and a distance value between the station 10 and a captured video image of the marker image 60 to set an entry path P.

Next, the mobile robot 100 may enter the station 10 based on the set entry path P.

Further, in the system for guiding a mobile robot to a station according to an embodiment of the present invention, the marker image 60 may be updated at set time intervals or each time the mobile robot 100 returns, and the data of the updated marker image 60 may be synchronized by the station 10 and the mobile robot 100.

As described above, the present invention may expose a large marker image 60 on the display 50 when the mobile robot 100 returns to the station 10, thereby enabling the mobile robot 100 to recognize the marker more quickly and accurately.

In addition, the present invention prevents the marker from being exposed to outsiders in normal situations by exposing the marker that guides the mobile robot 100 to return to the station 10 on the display 50 in video form only when necessary.

In particular, it may prevent interference with the mobile robot's operation from individuals with malicious intent, thereby improving the security vulnerability of the system for guiding a mobile robot to a station according to an embodiment of the present invention.

Meanwhile, the marker image 60 may be displayed while changing its size within a range from a maximum size that may be displayed on the display 50 to a minimum size that may be recognized by the mobile robot 100.

This will be described with reference to FIG. 4. In FIG. 4(a), it can be seen that the marker image 60 is displayed large enough to fill the screen of the display 50, and in FIG. 4(b), it can be seen that the marker image 60a is displayed small.

If the size of the marker image 60 is largely exposed on the display 50, it may not be favorable in terms of security and aesthetics. Therefore, by actively changing it to an appropriate size according to the situation, disharmony with the surrounding environment may be resolved.

Further, based on the distance value between the station 10 and the mobile robot 100, the marker image 60 may be displayed at a maximum size if a distance value farther than a set distance value is calculated, and the size of the marker image 60 may be gradually displayed smaller in proportion to the a distance value if a distance value closer than the set distance value is calculated.

The set distance value may be a distance value at which the marker can be optimally recognized from the image, captured by the mobile robot 100, of the marker image 60, and this set distance value may be set according to the camera's performance.

Therefore, the system for guiding a mobile robot to a station according to an embodiment of the present invention may capture the marker image 60 well from a long distance even if the distance between the mobile robot 100 and the station 10 is far, and may acquire necessary information from the captured image more quickly and accurately.

On the other hand, the marker image 60 may be rendered in a distorted form and displayed if the orientation value of the mobile robot 100 with respect to the station 10 is greater than ‘45 degrees’, so that the distortion of the marker image in the captured video image is reduced when the mobile robot 100 captures the marker image 60.

Reproducing the marker image 60 with arbitrary distortion will be described with reference to FIGS. 5 to 8. FIGS. 5 and 6 show the marker image 60 displayed without distortion. However, when the mobile robot 100 approaches the station 10 from an oblique direction, the marker image 60 may appear severely distorted as shown in FIG. 5, and the distortion may appear even more severe with a wide-angle camera lens.

If the marker image is captured with distortion, it may take a long time to analyze the image, or it may be analyzed as incorrect information.

FIGS. 7 and 8 illustrate the marker image 60 displayed with distortion on the display 50. In this case, when the mobile robot 100 captures the marker image 60, it may be captured with reduced distortion as shown in FIG. 7, which has the effect of enabling fast and accurate analysis of the captured image without errors.

On the other hand, the system for guiding a mobile robot to a station according to an embodiment of the present invention may include a warning light 70 installed on one side of the station 10, as shown in FIG. 4.

The warning light 70 may operate when the distance value between the mobile robot 100 and the station 10 falls within a set distance value as the mobile robot 100 returns to the station 10.

The warning light 70 may illuminate the floor to display the entry path of the mobile robot 100, and a pedestrian may recognize the light projected on the floor.

That is, the warning light 70 remains off in normal conditions and activates when the mobile robot 100 approaches the station 10.

The mobile robot 100 attempts to enter the station 10, but a general person cannot know the current path and reason for the mobile robot 100's travel.

However, a pedestrian may visually notice the light reflected on the floor, which can draw the pedestrian's attention, and the pedestrian can know which direction to move to avoid a collision with the mobile robot 100.

The warning light 70 may simply emit an intense light that can attract attention, but it may also output appropriate text and images, thereby allowing a pedestrian to more clearly understand the current situation.

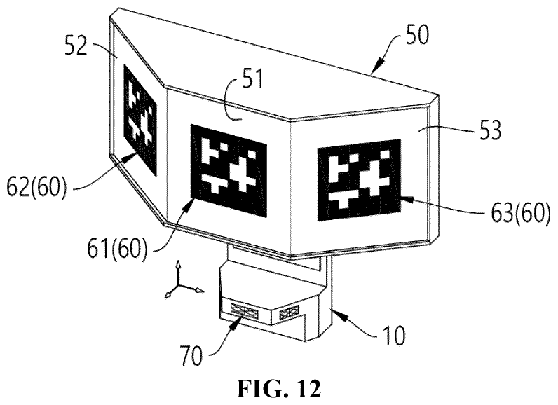

In the system for guiding a mobile robot to a station according to an embodiment of the present invention, the display 50 may have a plurality of screens, and a marker image 60 may be displayed on each screen. This will be described with reference to FIGS. 12 to 14.

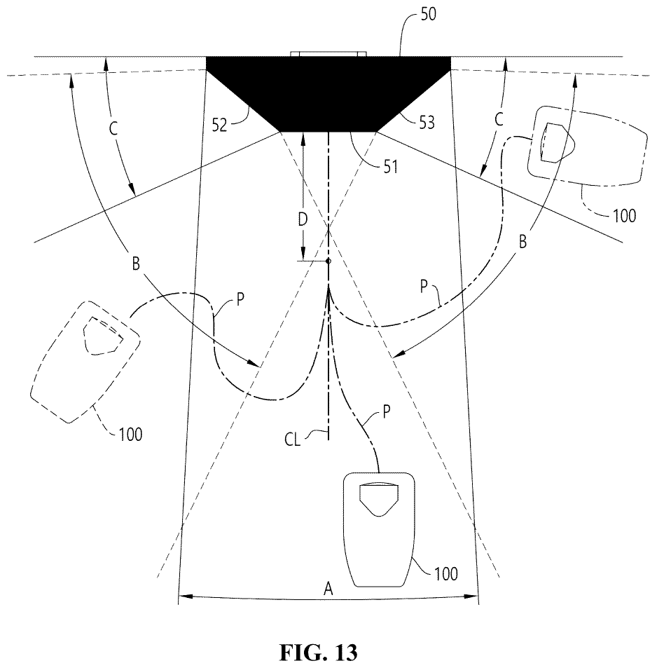

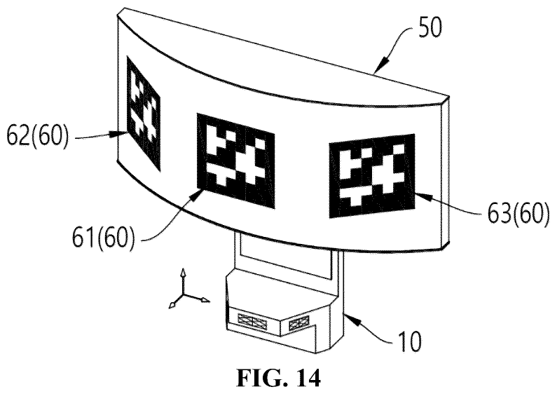

FIG. 12 is a diagram for explaining a system for guiding a mobile robot to a station according to another embodiment of the present invention. FIG. 13 is a diagram for explaining the operation of a station for a mobile robot according to another embodiment of the present invention. FIG. 14 is another example of a display in a system for guiding a mobile robot to a station according to an embodiment of the present invention.

The system for guiding a mobile robot to a station according to an embodiment of the present invention may have a three-dimensional display 50 at a station 10.

The display 50 shown in FIGS. 12 and 13 is a polyhedral display with at least three faces, and a marker image 60 may be displayed on each face.

More specifically, the display 50 may be formed with a first face 51, a second face 52, and a third face 53, as shown in FIGS. 12 and 13.

A first marker image 61 is displayed on the first face 51.

A second marker image 62 is displayed on the second face 52, which is adjacent to the first face 51 and forms a first obtuse angle with the first face 51.

A third marker image 63 is displayed on the third face 53, which is adjacent to the first face 51 on the side opposite to the second face 52 and forms a second obtuse angle with the first face 51.

The first, second, and third marker images 61, 62, and 63 each have respective recognition coordinates 40. In the embodiment of the present invention, since three markers are configured, there are three types of recognition coordinates 40.

The recognition coordinates 40 provide three-dimensional coordinate information, including orientation information of an X-axis 41, a Y-axis 42, and a Z-axis 43, and the orientation posture of the mobile robot may be estimated based on this orientation information.

The X-axis 41 is an axis indicating a direction perpendicularly passing through the reference point of marker 20, the Y-axis 42 is an axis indicating a horizontal direction from the reference point of marker 20, and the Z-axis 43 is an axis indicating a vertical direction from the reference point of marker 20.

That is, when the camera mounted on the mobile robot 100 captures the first, second, and third marker images 61, 62, and 63, the recognition coordinates 40 may be determined by analyzing each of the first, second, and third marker images 61, 62, and 63, as shown in FIG. 13.

This allows for the estimation of the orientation posture of the mobile robot 100, that is, what orientation value the mobile robot 100 has with respect to the station 10.

In addition, the mobile robot 100 is equipped with a distance sensor, which allows it to estimate how far it is from the station 10.

Alternatively, the distance between the mobile robot 100 and the station 10 may be estimated by analyzing the captured video.

Even if the mobile robot 100 is at an arbitrary position when the mobile robot 100 enters the station, one or more of the first, second, and third marker images 61, 62, and 63 may always be captured by the camera of the mobile robot 100, as shown in FIG. 13.

Meanwhile, the first and second obtuse angles may be between 120 degrees and 135 degrees.

The characteristics of each area where the mobile robot is located will be described with reference to FIG. 13.

When the mobile robot is in a first region A, it may capture all of the first, second, and third marker images 61, 62, and 63. In this case, the mobile robot 100 may set the travel path P to the shortest distance, and adjustments to the driving direction may be minimized.

In particular, the X-axis 41 orientation value of the first marker image 61 may converge to ‘0’, and if the X-axis 41 orientation value of the first marker image 61 is ‘0’, it may be understood that the mobile robot 100 has docked at the correct position when docking relative to the station 10.

If the first and second obtuse angles are 120 degrees or more, the mobile robot 100 may accurately recognize all of the first, second, and third marker images 61, 62, and 63 when it is in the first region A.

When the mobile robot 100 is in a second region B, it may capture and recognize the first and second marker images 61 and 62, or it may capture and recognize the first and third marker images 61 and 63.

For example, the mobile robot 100 may be in the second region B, shifted to one side with respect to the station 10. In this case, it may capture at least two markers and obtain three-dimensional coordinate information from each marker in the captured image.

From the obtained three-dimensional coordinate information, it may be determined whether the mobile robot 100 is shifted to the left or to the right.

That is, when the mobile robot 100 is on the left side of the station 10, the X-axis 41 and Y-axis 42 of each recognition coordinate 40 have positive (+) values. Therefore, a travel path P may be set to allow the mobile robot 100 to move to the right and align so that the X-axis 41 value of the first marker image 61 converges to ‘0’.

Meanwhile, if the distance between the mobile robot 100 and the station 10 is closer than the set reference distance D, a travel path P may be set to make the mobile robot 100 move backward so that the X-axis 41 value of the first marker image 61 converges to ‘0’.

When the mobile robot 100 is in a third region C, it may not recognize the first marker image 61 but may recognize the second marker image 62 or the third marker image 63.

For example, the mobile robot 100 may be in the third region C, excessively shifted to one side with respect to the station 10. In this case, it may capture at least one marker, and obtain three-dimensional coordinate information from each marker in the captured image.

As described previously, from the obtained three-dimensional coordinate information, it can be determined whether the mobile robot 100 is shifted to the left or to the right.

As shown in FIG. 13, even when the mobile robot 100 is excessively shifted to the right with respect to the station 10, the mobile robot 100 may recognize the second marker image 62. At this time, since the X-axis 41 and Y-axis 42 of the recognition coordinates 40 have negative (−) values, a travel path P may be set so that the X-axis 41 value of the first marker image 61 converges to ‘0’.

Meanwhile, if the distance between the mobile robot 100 and the station 10 is closer than a set reference distance D, a travel path P may be set to make the mobile robot 100 move backward so that the X-axis 41 value of the first marker image 61 converges to ‘0’.

If the first and second obtuse angles are 135 degrees or less, the mobile robot 100 may accurately recognize the first and second marker images 61 and 62 or the first and third marker images 61 and 63 when it is in the second region B2.

Furthermore, if the first and second obtuse angles are 135 degrees or less, the mobile robot 100 may accurately recognize the second marker image 62 or the third marker image 63 when it is in the third region B3.

That is, in the system for guiding a mobile robot to a station according to an embodiment of the present invention, the mobile robot 100 may recognize at least one marker even if it is at an arbitrary position, by forming the first and second obtuse angles between 120 and 135 degrees. Based on the X-axis 41 of the three-dimensional coordinate information of the recognized marker, the travel path P may be modified to correctly align the posture of the mobile robot 100 and generate an optimal travel path P.

Further, in the system for guiding a mobile robot to a station according to an embodiment of the present invention, the display 50 may have a convex curved shape, and a plurality of marker images 60 may be arranged apart in the horizontal direction and displayed. This will be described with reference to FIG. 14.

The display 50 shown in FIG. 14 has a convex curved surface in the front direction. The display 50 may display a plurality of marker images 60, and FIG. 14 illustrates an example where three marker images 61, 62, and 63 are displayed.

Accordingly, with reference to FIG. 13, the mobile robot 100 will be located in one of the first, second, and third regions A, B, and C. Regardless of which region it is in, it may recognize two or three of the first, second, and third marker images 61, 62, and 63.

Therefore, the mobile robot 100 may acquire recognition coordinate 40 information from the recognized marker image 60 to estimate the orientation value and distance value with respect to the station 10, and set a travel path P based on the estimated values, and the mobile robot 100 may enter the station 10 along the travel path P.

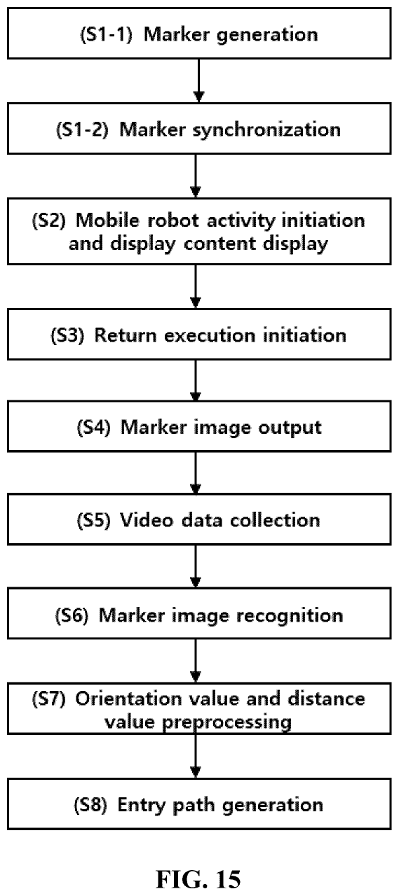

The mobile robot 100 may perform functions such as charging, replenishing water, or emptying dust at a station depending on its designated function. The operation of the system for guiding a mobile robot to a station according to an embodiment of the present invention will be described with reference to FIG. 15. FIG. 15 is a flowchart for explaining the operation of the system for guiding a mobile robot to a station according to an embodiment of the present invention.

First, the station 10 may generate a marker (S1-1) and implement marker synchronization

### (S1-2).

### First Step (S1-1, S1-2): Marker Generation and Synchronization

The marker is data for the marker image 60 to be exposed on the display 50, and this marker data may be synchronized through data communication between the station 10 and the mobile robot 100.

That is, when the mobile robot 100 returns to the station 10, the station 10 with specific coordinates to which it should navigate is set.

Second step (S2): Mobile robot activity initiation and display content reproduction

As shown in FIG. 9, content that a company or organization wants to promote may be displayed on the display 50.

In addition, as shown in FIG. 10, the current status information of the mobile robot 100 may be displayed on the display 50. The current status information may display, for example, its location, whether any incidents have occurred, and whether temperature, humidity, fine dust levels, etc., are appropriate.

### Third Step (S3): Return Execution Initiation

A return command may be executed for the mobile robot 100 to return to the station 10 for charging or service.

### Fourth Step (S4): Marker Image Output

As shown in FIG. 11, the marker image 60 may be output over the content on the display 50. Alternatively, as shown in FIG. 6, the marker image 60 may be output alone on the display 50.

### Fifth Step (S5): Video Data Collection

The mobile robot 100 moves to the vicinity of the station 10 by autonomous driving and collects video data by capturing images.

### Sixth Step (S6): Marker Image Recognition

When the mobile robot 100 captures the marker image 60, it analyzes the captured image.

### Seventh Step (S7): Orientation Value and Distance Value Preprocessing

The mobile robot 100 may calculate a more accurate orientation value and distance value from the marker image 60 in the captured image.

### Eighth Step (S8): Entry Path Generation

Based on the orientation and distance values calculated in the seventh step S7, an entry path P is generated as shown in FIG. 13. Next, the mobile robot 100 travels along the entry path P to enter the station 10.

While embodiments of the present invention have been described with reference to the accompanying drawings, a person skilled in the art to which the present invention pertains will understand that the present invention can be embodied in other specific forms without departing from its technical spirit or essential features.

Therefore, it should be understood that the embodiments described above are illustrative in all respects and not limiting. The scope of the present invention is defined by the appended claims, and all modifications or variations derived from the meaning and scope of the claims and their equivalents should be interpreted as being included within the scope of the present invention.

### INDUSTRIAL APPLICABILITY

A system for guiding a mobile robot to a station according to an embodiment of the present invention can be used for charging or maintaining a mobile robot.

1. A system for guiding a mobile robot to a station, the system comprising:
a station to which a mobile robot is connected to charge the mobile robot; and
a display installed at the station, on which a video is displayed,
wherein a marker image comprising orientation information of an X-axis, a Y-axis, and a Z-axis is displayed on the display, and
the mobile robot calculates an orientation value and distance value relative to the station from a captured video image of the marker image to set an entry path, and enters the station based on the set entry path,
wherein the marker image is displayed while changing its size within a range from a maximum size that can be displayed on the display to a minimum size that can be recognized by the mobile robot,
wherein the marker image is displayed at a maximum size when a distance value farther than a set distance value is calculated based on the distance value between the station and the mobile robot, and a size of the marker image is gradually displayed smaller in proportion to the distance value when a distance value closer than the set distance value is calculated, and
wherein the marker image is rendered in a distorted form and displayed when the orientation value of the mobile robot with respect to the station is greater than 45 degrees, so that the distortion of the marker image in the captured video image is reduced when the mobile robot captures the marker image.

2. The system according to claim 1, wherein the marker image is updated at set time intervals or each time the mobile robot returns, and the data of the updated marker image is synchronized by the station and the mobile robot.

3-5. (canceled)

6. The system according to claim 1, further comprising: a warning light installed on one side of the station, wherein the warning light illuminates a floor to display the entry path of the mobile robot when the distance value between the mobile robot and the station falls within a set distance value as the mobile robot returns to the station.

7. The system according to claim 1, wherein the display has a plurality of screens, and a marker image is displayed on each screen.

8. The system according to claim 1, wherein the display has a convex curved shape, and a plurality of marker images are arranged apart in the horizontal direction and displayed.
